(19) United States
(12) Patent Application Publication
(10) Pub. No.: US 2015/0055520 A1
(43) Pub. Date: Feb. 26, 2015

(54) BASE STATION AND COMMUNICATION CONTROL METHOD

(71) Applicant: KYOCERA CORPORATION, Kyoto (JP)

(72) Inventor: Toru Sahara, Yokohama-shi (JP)

(73) Assignee: KYOCERA CORPORATION, Kyoto (JP)

(21) Appl. No.: 14/387,340

(22) PCT Filed: Mar. 8, 2013
(86) PCT No.: PCT/JP2013/001535

§ 371 Date: Sep. 23, 2014

(30) Foreign Application Priority Data
Mar. 28, 2012 (JP) 2012-074914
Mar. 28, 2012 (JP) 2012-074933

(51) Int. Cl. H04W 72/04; H04W 88/08; H04L 5/14

(52) U.S. Cl. CPC H04W 72/0453; H04L 5/14; H04W 88/08
USPC 370/280

(57) ABSTRACT

A control unit 130 assigns a first new call to a radio resource of a frequency channel with a small interference power and, when there is an available radio resource, assigns new calls after the first new call to radio resources of a frequency channel the same as, or adjacent to, the frequency channel of the radio resource of the first new call. The control unit 130, when there is no available radio resource, selects a combination of a multiplex call originator and a multiplex call receiver to which space division multiplexing may be carried out and, by calculating multiplexing priorities, selects a combination of a multiplex call originator and a multiplex call receiver having high priorities. Then, the control unit 130 generates an available radio resource by carrying out the space division multiplexing and assigns the new calls after the first new call to the generated radio resources.

### CROSS REFERENCE TO RELATED APPLICATION

This application claims priority to and the benefit of Japanese Patent Application No. 2012-074914 and Japanese Patent Application No. 2012-074933 both filed on Mar. 28, 2012, the entire contents of which are incorporated herein by reference.

### TECHNICAL FIELD

The present invention relates to a base station for carrying out a radio communication by using one of Time Division Multiple Access scheme and Time Division Multiple Access/Time Division Duplex scheme, and Space Division Multiple Access scheme, and also to a communication control method.

### BACKGROUND ART

In a radio communication system of PHS and the like, one of Time Division Duplex (TDD) scheme and Time Division Multiple Access/Time Division Duplex scheme, and Space Division Multiple Access (SDMA) scheme are employed.

Conventionally, the radio communication system described above, in performing space division multiplexing, generates an available radio resource by employing the SDMA scheme and assigns a mobile station to the available radio resource generated (see Patent Document 1 and Patent Document 2).

Conventionally, for example, when a new call is generated and there are available radio resources, the base station, as illustrated in FIG. 11, selects a radio resource of a frequency channel with a minimum interfering wave (a frequency channel in best receiving condition) among the available radio resources and assigns the new call thereto. When the new call is generated and there is no available radio resource, the base station, based on information about a power ratio and a spatial correlation value of an existing call, selects a combination of a multiplex call originator (a calling side that carries out the space division multiplexing) and a multiplex call receiver (a receiving side of the space division multiplexing call), generates an available radio resource by carrying out the space division multiplexing by means of TCH switching as illustrated in FIG. 12, and then assigns the new call to the available radio resource as illustrated in FIG. 13.

### RELATED ART DOCUMENTS

### Patent Documents

Patent Document 1: Japanese Patent Application Laid-Open Publication No. 2003-188790

Patent Document 2: Japanese Unexamined Patent Application Publication No. 2005-505973

### SUMMARY OF INVENTION

### Technical Problem

Since the radio communication system described above selects the mobile station for assigning one radio resource by using a result of the power ratio and the spatial correlation value of the existing call, when there is a frequency difference between a radio resource (a multiplex originating resource) of one mobile station (the multiplex call originator) and a radio resource (a multiplex receiving resource) of another mobile station (the multiplex call receiver) to which the mobile station moves, due to an influence by frequency selective fading in the radio channel, a correlation becomes different between before and after the space division multiplexing, inhibiting an appropriate selection of the space division multiplexing.

An object of the present invention in view of such a problem is to provide a base station capable of, even in an environment with the frequency selective fading, selecting more stable space division multiplexing and also to provide a communication control method.

### Solution to Problem

In order to achieve the above object, a base station according to the present invention employing a TDD scheme and having a plurality of antennas for carrying out a radio communication by using an adaptive array method, wherein the base station assigning, to a mobile station having made a connection request, a radio resource of a frequency band the same as, or adjacent to, a frequency band of a radio resource used by another mobile station having made the connection request immediately prior to the mobile station and being connected, setting a multiplexing priority to each of mobile stations being connected relative to other mobile stations being connected, and selecting, when there is no available radio resource to assign the mobile station that has made the connection request, a plurality of mobile stations being connected based on the multiplexing priority and assigning the selected plurality of mobile stations to one radio resource by employing an SDMA scheme.

Preferably, the multiplexing priority is set based on a spatial correlation value and a power ratio of each of the mobile stations being connected relative to other base stations being connected.

In order to achieve the above object, a base station according to the present invention employing a TDD scheme and having a plurality of antennas for carrying out a radio communication by using an adaptive array method, wherein the base station setting a multiplexing priority to each of mobile stations being connected relative to other mobile stations being connected based at least on a frequency difference of radio resources of the mobile stations, and selecting a plurality of mobile stations being connected based on the multiplexing priority and assigning the selected plurality of mobile stations to one radio resource by employing an SDMA scheme.

Preferably, the multiplexing priority is set based further on a spatial correlation value and a power ratio of each of the mobile stations being connected relative to other mobile stations being connected.

Preferably, a mobile station having made a connection request is assigned to a radio resource of a frequency band the same as, or adjacent to, a frequency band of a radio resource used by another base station having made the connection request immediately prior to the mobile station and being connected.

A communication control method of a base station according to the present invention employing a TDD scheme and having a plurality of antennas for carrying out a radio communication by using an adaptive array method, the communication control method includes: a step of assigning, to a mobile station having made a connection request, a radio resource of a frequency band the same as, or adjacent to, a frequency band of a radio resource used by another mobile station having made the connection request immediately prior to the mobile station and being connected; a step of setting a multiplexing priority to each of mobile stations being connected relative to other mobile stations being connected; and a step of selecting, when there is no available radio resource to assign the mobile station that has made the connection request, a plurality of mobile stations being connected based on the multiplexing priority and assigning the selected plurality of mobile stations to one radio resource by employing an SDMA scheme.

A communication control method of a base station according to the present invention employing a TDD scheme and having a plurality of antennas for carrying out a radio communication by using an adaptive array method, the communication control method includes: a step of setting a multiplexing priority to each of mobile stations being connected relative to other mobile stations being connected based at least on a frequency difference of radio resources between the mobile stations; and a step of selecting a plurality of mobile stations being connected based on the multiplexing priority and assigning the selected plurality of mobile stations to one radio resource by employing an SDMA scheme.

### Effect of the Invention

According to the present invention, even in an environment with frequency selective fading, more stable space division multiplexing may be selected.

### BRIEF DESCRIPTION OF DRAWINGS

FIG. 1 is a diagram illustrating a schematic configuration of a radio communication system including a base station according to an embodiment of the present invention;

FIG. 2 is a flowchart illustrating an operation of space division multiplexing according to a first embodiment;

FIG. 3 is a format diagram of radio resources illustrating an operation according to the first embodiment;

FIG. 4 is a format diagram of the radio resources illustrating the operation according to the first embodiment;

FIG. 5 is a format diagram of the radio resources illustrating the operation according to the first embodiment;

FIG. 6 is a flowchart illustrating an operation of the space division multiplexing according to a second embodiment;

FIG. 7 is a format diagram of the radio resources illustrating an operation according to the second embodiment;

FIG. 8 is a format diagram of the radio resources illustrating the operation according to the second embodiment;

FIG. 9 is a format diagram of the radio resources illustrating the operation according to the second embodiment;

FIG. 10 is a flowchart illustrating an operation of the space division multiplexing according to a third embodiment;

FIG. 11 is a diagram illustrating a conventional procedure for assigning a new call to the radio resource;

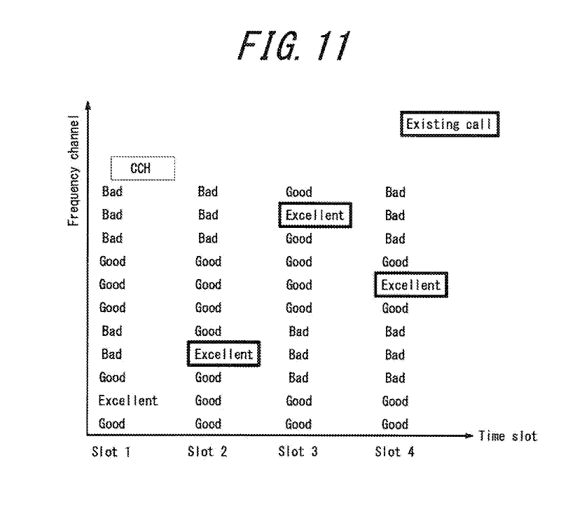

FIG. 12 is a diagram illustrating a conventional procedure for assigning the new call to the radio resource; and

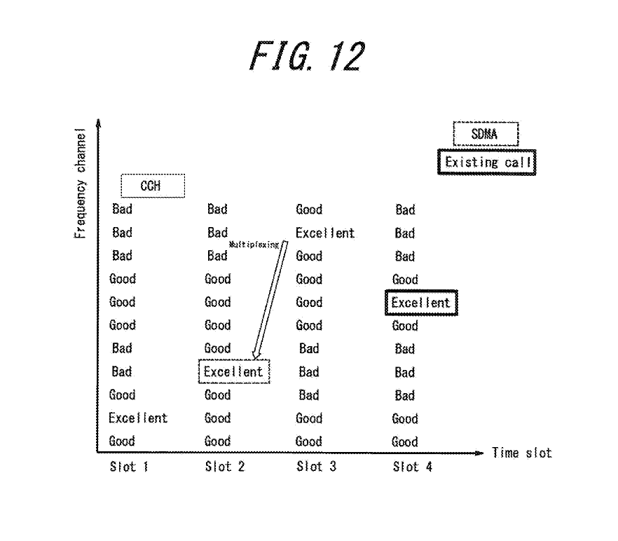

FIG. 13 is a diagram illustrating a conventional procedure for assigning the new call to the radio resource.

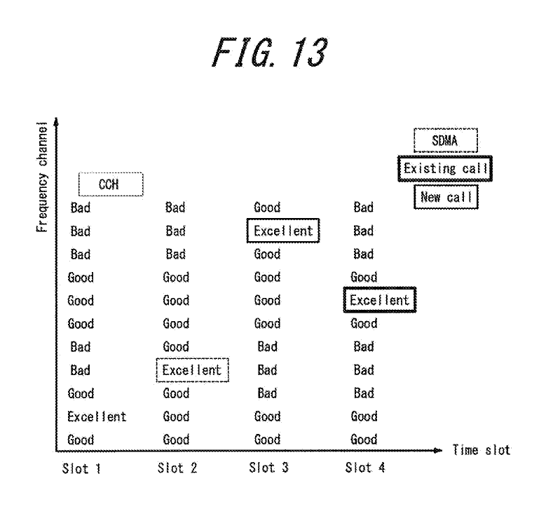

### DESCRIPTION OF EMBODIMENTS

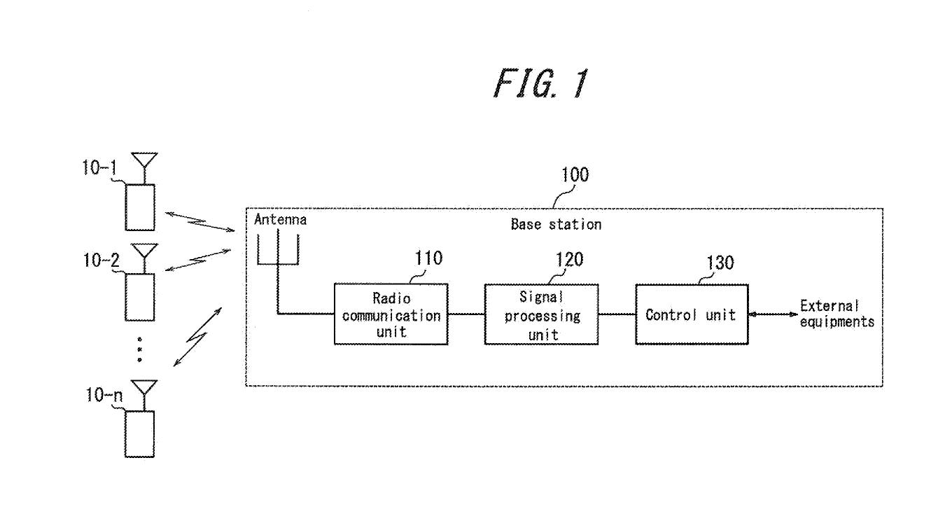

Hereinafter, embodiments of the present invention will be described with reference to the accompanying drawings. FIG. 1 is a diagram illustrating a schematic configuration of a radio communication system including a base station according to the embodiment of the present invention. The radio communication system illustrated in FIG. 1 includes mobile stations 10-1 to 10-n (hereinafter, referred to as a mobile station 10) and a base station 100. Note that, although external equipments such as a network, a server and the like are connected to the base station 100, descriptions thereof will be omitted.

The base station 100 carries out a radio communication with the mobile station 10 by using Time Division Multi Access/Time Division Duplex (TDMA/TDD) scheme employed by a PHS and the like. Here, according to the first embodiment, it is assumed that the base station 100, by using four uplink time slots and four downlink time slots, carries out the radio communication with the mobile station 10. It is also assumed that CCH (Control Channel) is assigned to one of the uplink time slots and one of the downlink time slots. Although the base station 100 assigns a combination of the uplink time slot and the downlink time slot to the mobile station 10, the combination of the uplink time slot and the downlink time slot will be simply referred to as a time slot according to the first embodiment.

The base station 100 carries out adaptive array control with a plurality of antenna elements and, by using the same frequency channel (frequency band) and the same time slot in accordance with a Space Division Multiple Access (SDMA) scheme, transmits and receives radio signals between a plurality of mobile stations 10.

When receiving a call connection request transmitted from the mobile station 10, the base station 100, according to the call connection request, assigns a radio resource designated in the frequency channel and the time slot to the mobile station 10.

Here, according to the first embodiment, a call connection refers to TCH (Traffic Channel) used in a voice communication, a data communication and the like, and the call connection request refers to a TCH establishment request for requesting an assignment of a new TCH (call connection) made by the mobile station 10 to the base station 100.

Note that the base station 100 basically carries out the radio communication by using the TDMA/TDD scheme and, when receiving the call connection request from a new mobile station 10 and there is no available radio resource, carries out the radio communication in accordance with the SDMA scheme with a plurality of mobile stations 10 with which the base station 100 has already been carrying out the radio communication, in order to generate an available radio resource for the new mobile station 10.

Next, a configuration of the base station 100 will be described. Note that FIG. 1 illustrates only components of the base station 100 associated with the present invention. The base station 100 includes a radio communication unit 110 connected to an adaptive array antenna, a signal processing unit 120, and a control unit 130.

The radio communication unit 110 carries out a radio processing such as down-conversion to the radio signal received from the mobile station 10 via the antenna and outputs the processed signal to the signal processing unit 120. The radio communication unit 110 also carries out radio processing such as up-conversion to a signal input from the signal processing unit 120 and transmits the processed radio signal to the mobile station 10 via the antenna.

The signal processing unit 120 controls the radio communication unit 110 to transmit the radio signal whose directivity has been controlled and carries out the adaptive array control so as to increase sensitivity of the signal input from the radio communication unit 110. Since the signal processing unit 120 carries out the adaptive array control, the base station 100 carries out the radio communication in accordance with the SDMA scheme with a plurality of mobile stations 10 by using the same time slot and the same frequency channel.

The control unit 130 controls the operation of the signal processing unit 120 based on the TDMA/TDD scheme and the SDMA scheme.

Next, an operation of the base station 100 to carry out space division multiplexing will be described. The signal processing unit 120, upon receiving a carrier sense instruction from the control unit 130, carries out carrier sense of interference wave power of all frequency channels having the available radio resources and notifies the control unit 120 of a result. The signal processing unit 120 preliminarily obtains channel information (positions) of a multiplex call originator and a multiplex call receiver from the control unit 130. The signal processing unit 120 receives a signal via the antenna and the radio communication unit 110 and, from an array response vector of the multiplex call originator (m) and the multiplex call receiver (l), calculates a spatial correlation value therebetween and notifies the control unit 130 of the spatial correlation value. Formula 1 expresses the array response vector, and k represents an antenna element number. Formula 2 is a calculation formula of the spatial correlation value. The spatial correlation value represents the proximity of a direction having two mobile stations. When the spatial correlation value is large, the two mobile stations are positioned substantially in the same direction and thus the base station has difficulty in separating the signals received from these mobile stations.

$$\begin{matrix}h ( k ) = \frac{{\sum }_{t = 1}^{Number of Reference Signals} ( \frac{y ( k , t )}{s ( t )} )}{Number of Reference Signals} & [ Formula 1 ] \\ Spatial Correlation Value ( l , m ) = \frac{\vert {\sum }_{k = 1}^{Number of Antennas} ( {h}_{l} ( k ) * {{h}_{m} ( k )}^{*} ) \vert}{\vert {h}_{l} \vert * \vert {h}_{m} \vert} & [ Formula 2 ]\end{matrix}$$

The signal processing unit 120 calculates a power ratio (DD ratio: Desired to Desired Ratio), a transmission timing difference, power levels, fading rates, and instantaneous errors of the multiplex call receiver and the multiplex call originator and notifies the control unit 130 of them. The power ratio (DD ratio) represents a ratio of reception power levels between the mobile stations and, when a reception power ratio (DD ratio) is high, the base station has difficulty in separating the signals received from the mobile stations.

The control unit 130, when a first new call is generated, selects a frequency channel with a small interference wave having an excellent result of the carrier sense and assigns the first new call to an available radio resource of the frequency channel. The control unit 130, when a second or subsequent new call is generated and there is an available radio resource, selects a frequency channel the same as, or adjacent to, a frequency channel of the first new call and assigns the second or subsequent new call to the available radio resource of the selected frequency channel. The control unit 130, when there is no available radio resource, determines the validity of the space division multiplexing of the multiplex call originator and the multiplex call receiver based on the reception power ratio, the spatial correlation value, the transmission timing difference, the power levels, the fading rates, and the instantaneous errors notified by the signal processing unit 120 and selects a combination of the multiplex call originator and the multiplex call receiver to which the space division multiplexing may be carried out. The determination of the validity of the space division multiplexing is made by comparing between an index representing communication quality such as the reception power ratio and a predetermined threshold of the index.

Further, the control unit 130, based on the spatial correlation value and the reception power ratio of the selected combination of the multiplex call originator and the multiplex call receiver, calculates a multiplexing priority of each of the selected combination. The multiplexing priority is set to be low when the spatial correlation value is high and when the reception power ratio is high. The control unit 130 selects a combination of a multiplex call originator and a multiplex call receiver those having high priorities and, by carrying out the space division multiplexing of the multiplex call originator to the multiple call receiver by means of TCH switching, assigns one radio resource to the multiplex call originator and the multiplex call receiver. Then, the control unit 130 assigns the second or subsequent new call to an available radio resource.

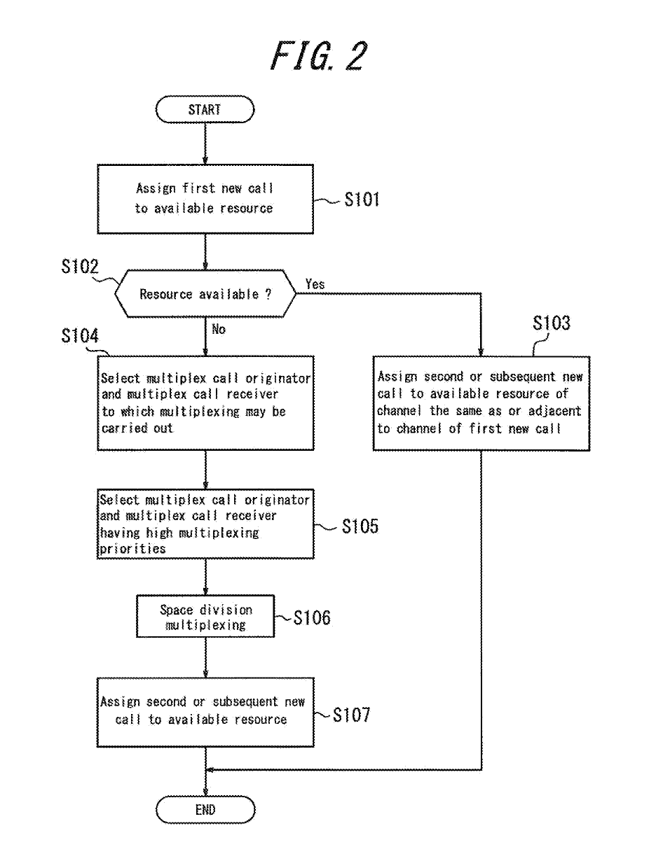

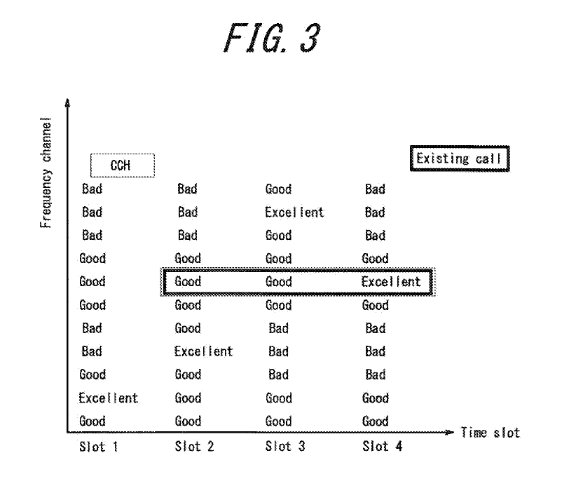

FIG. 2 is a flowchart illustrating the operation of the space division multiplexing according to the first embodiment. FIGS. 3 to 5 are format diagrams of the radio resources for illustrating the operation of the space division multiplexing according to the first embodiment. The control unit 130 selects a frequency channel with a small interference wave in all time slots except a time slot (hereinafter, referred to as a CCT channel slot) to which CCH (Control Channel) is assigned, and then assigns the first new call to the available radio resource of the selected frequency channel (S101). The control unit 130, when there is an available radio resource (Yes at S102), assigns the second or subsequent new call to the radio resource of the frequency channel the same as, or adjacent to, the frequency channel of the radio resource of the first new call (S103). FIG. 3 illustrates assignment of the second or subsequent new call to the available radio resource of the frequency channel the same as the frequency channel of the radio resource of the first new call.

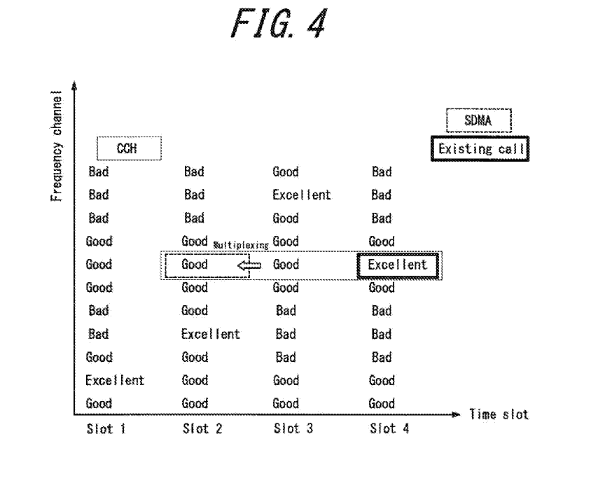

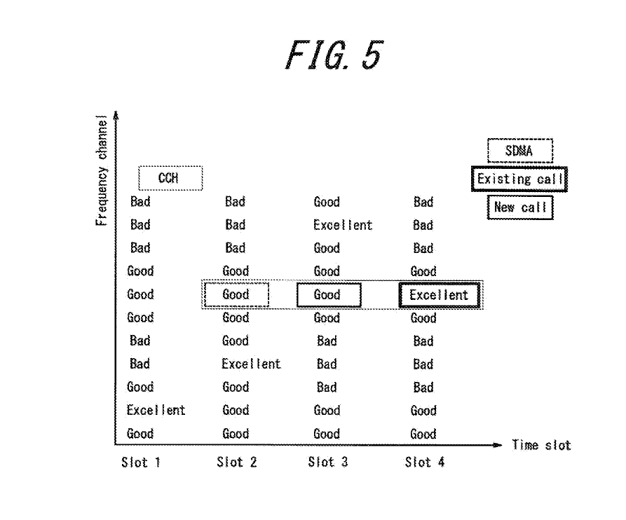

The control unit 130, when there is no available radio resource (No at S102), based on information about a spatial correlation value of an existing call, the reception power ratio, the transmission timing difference, the power levels, the fading rates, and the instantaneous errors, selects the combination of the multiplex call originator and the multiplex call receiver to which the space division multiplexing may be carried out (S104). Further, the control unit 130 selects the combination of the multiplex call originator and the multiplex call receiver those having high multiplexing priorities (S105), carries out the space division multiplexing thereto as illustrated in FIG. 4 (S106), generates the available radio resource, and then assigns the second or subsequent new call to the available radio resource as illustrated in FIG. 5 (S107).

Next, a second embodiment of the present invention will be described. The radio communication system including the base station according to the second embodiment has the same configuration as that of the first embodiment but operates the space division multiplexing in a different manner.

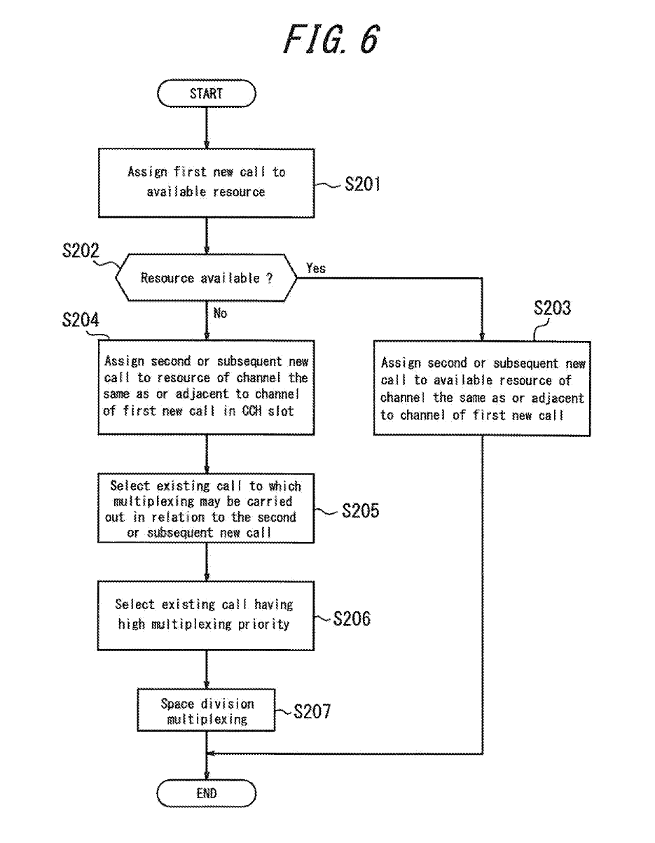

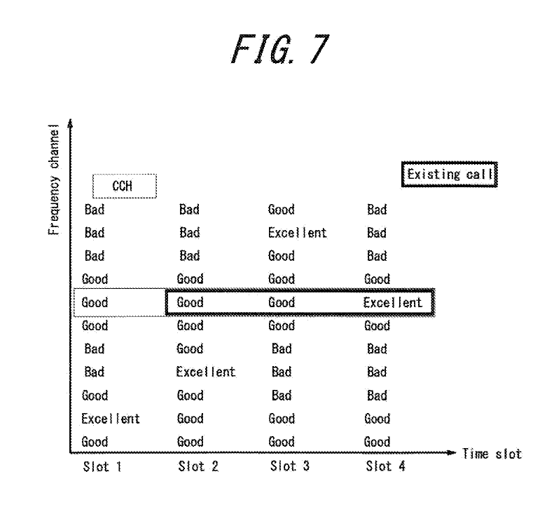

FIG. 6 is a flowchart illustrating the operation of the space division multiplexing according to the second embodiment. FIGS. 7 to 9 are the format diagrams of the radio resources for illustrating the operation of the space division multiplexing according to the second embodiment. According to the second embodiment, when there is no available radio resource, a new call of a circuit switched call is assigned to a CCH time slot. The PHS does not use the CCH time slot for the circuit switched call. According to the second embodiment, therefore, when there is no available radio resource at the time of channel selection, the new call of the circuit switched call is assigned to the CCH time slot and then the space division multiplexing is carried out by means of the TCH switching. Note that this operation may be carried out only by a base station that may carry out a communication in the same time slot by using a plurality of radio communication units.

The control unit 130 selects a frequency channel with a small interference wave in all time slots including the CCH time slot and assigns the first new call to the available radio resource of the selected frequency channel (S201). The control unit 130, when there is an available radio resource (Yes at S203), assigns the second or subsequent new call to the radio resource of the frequency channel the same as, or adjacent to, the frequency channel of the radio resource of the first new call (S203). FIG. 7 illustrates assignment of the second or subsequent new call to the available radio resource of the frequency channel the same as the frequency channel of the radio resource of the first new call.

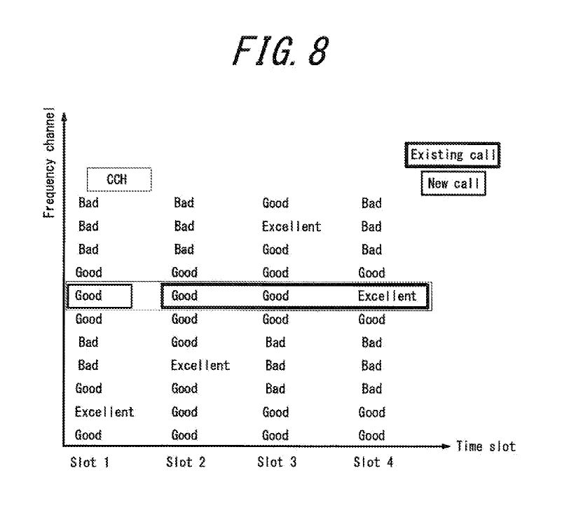

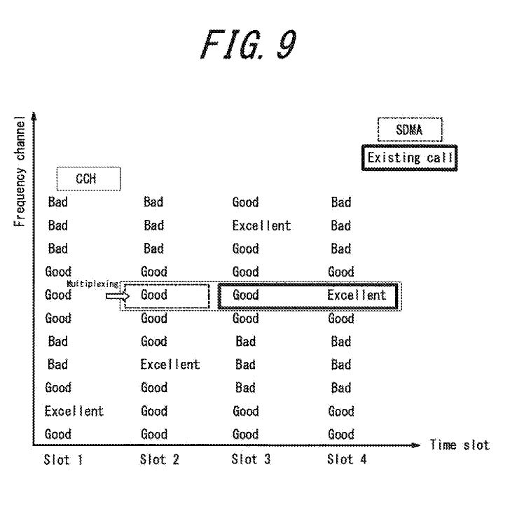

The control unit 130, when there is no available radio resource at the time of generation of the second or subsequent new call (No at S202), assigns the second or subsequent new call to the radio resource of the frequency channel the same as, or adjacent to, the frequency channel of the radio resource of the existing call in the CCH time slot (S204). FIG. 8 illustrates assignment of the second or subsequent new call to the radio resource of the frequency channel the same as the frequency channel of the radio resource of the existing call in the CCH time slot. Further, the control unit 130, based on the information about the spatial correlation value, the reception power value, the transmission timing difference, the power levels, the fading rates, and the instantaneous errors of the second or subsequent new call assigned to the CCH time slot and the existing call, selects the existing call (the multiplex call receiver) to which the space division multiplexing may be carried out in relation to the second or subsequent new call assigned to the CCH time slot (S205), and further selects an existing call (the multiplex call receiver) having a high multiplexing priority to the second or subsequent new call (S206) and, as illustrated in FIG. 9, carries out the space division multiplexing of the second or subsequent new call in relation to the existing call (the multiplex call receiver) (S207).

According to the second embodiment, since there is no need for carrying out the space division multiplexing of a call in communication by means of the TCH switching, communication quality of the call in communication may be maintained.

Next, a third embodiment of the present invention will be described. The radio communication system including the base station according to the third embodiment has the same configuration as that of the first embodiment but a communication scheme used by the base station and the mobile stations and the operation of the space division multiplexing carried out by the base station are different from those of the first embodiment.

In FIG. 1, the base station 100 carries out the radio communication with the mobile station 10 by using the Time Division Duplex (TDD) scheme employed by the PHS and the like. Here, according to the third embodiment, it is assumed that the base station 100 carries out the radio communication with the mobile station 10 by using four uplink time slots and four downlink time slots. It is also assumed that the CCH (Control Channel) is assigned to one of the uplink time slots and one of the downlink time slots. Note that, although the base station assigns a combination of the uplink time slot and the downlink time slot to the mobile station 10, the combination of the uplink time slot and the downlink time slot will be simply referred to as the time slot according to the third embodiment.

The base station 100 carries out the adaptive array control by using a plurality of antenna elements and transmits/receives the radio signals to/from a plurality of mobile stations 10 by using the same time slot in accordance with the Space Division Multiple Access (SDMA) scheme.

The base station 100 also, upon reception of the call connection request transmitted from the mobile station 10, assigns the radio resource designated in the time slot to the mobile station 10 in response to the call connection request.

Here, according to the third embodiment, the call connection refers to TCH (Traffic Channel) that is used in the voice communication and the data communication, and the call connection request refers to the TCH establishment request for requesting the assignment of the new TCH (call connection) made by the mobile station 10 to the base station 100.

Note that the base station 100 basically carries out the radio communication by using the TDD scheme and, when receiving the call connection request from a new mobile station 10 and there is no available radio resource, carries out the radio communication in accordance with the SDMA scheme with a plurality of mobile stations 10 with which the base station 100 has already been carrying out the radio communication, in order to generate an available radio resource for the new mobile station 10.

Next, the configuration of the base station 100 will be described. Note that FIG. 1 illustrates only the components of the base station 100 associated with the present invention. The base station 100 includes the radio communication unit 110 connected to the adaptive array antenna, the signal processing unit 120, and the control unit 130.

The radio communication unit 110 carries out the radio processing such as the down-conversion to the radio signal received from the mobile station 10 via the antenna and outputs the processed signal to the signal processing unit 120. Also, the radio communication unit 110 carries out the radio processing such as the up-conversion to the signal input from the signal processing unit 120 and transmits the processed radio signal to the mobile station 10 via the antenna.

The signal processing unit 120 controls the radio communication unit 110 to transmit the radio signal whose directivity has been controlled and carries out the adaptive array control so as to increase the sensitivity of the signal input from the radio communication unit 110. Since the signal processing unit 120 carries out the adaptive array control, the base station 100 carries out the radio communication in accordance with the SDMA scheme with a plurality of mobile stations 10 by using the same time slot.

The control unit 130 controls the operation of the signal processing unit 120 based on the TDD scheme and the SDMA scheme.

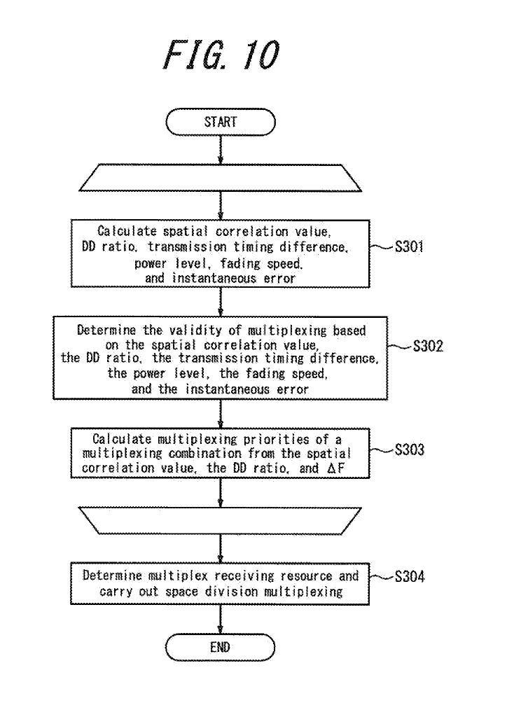

Next, an operation of the base station 100 to carry out the space division multiplexing according to the third embodiment will be described with reference to a flowchart in FIG. 10. The signal processing unit 120 preliminarily obtains positions of the multiplex originating resource and the multiplex receiving resource from the control unit 130. The signal processing unit 120 receives the signal via the antenna and the radio communication unit 110 and, from an array response vector of the multiplex originating resource (m) and the multiplex receiving resource (1), calculates the spatial correlation value thereof and notifies the control unit 130 of the spatial correlation value. Formula 3 expresses the array response vector, and k represents the antenna element number. Formula 4 is a calculation formula of the spatial correlation value. The spatial correlation value represents the proximity of the direction having two mobile stations. When the spatial correlation value is large, the two mobile stations are positioned substantially in the same direction and thus the base station has difficulty in separating the signals received from these mobile stations.

$$\begin{matrix}h ( k ) = \frac{{\sum }_{t = 1}^{Number of Reference Signals} ( \frac{y ( k , t )}{s ( t )} )}{Number of Reference Signals} & [ Formula 3 ] \\ Spatial Correlation Value ( l , m ) = \frac{\vert {\sum }_{k = 1}^{Number of Antennas} ( {h}_{l} ( k ) * {{h}_{m} ( k )}^{*} ) \vert}{\vert {h}_{l} \vert * \vert {h}_{m} \vert} & [ Formula 4 ]\end{matrix}$$

The signal processing unit 120 calculates the power ratio (DD ratio: Desired to Desired Ratio), the transmission timing difference, the power levels, the fading rates, and the instantaneous errors of the multiplex originating resource and the multiplex receiving resource and notifies the control unit 130 of them (S301). The power ratio (DD ratio) represents the ratio of the reception power levels between the mobile stations and, when the reception power ratio (DD ratio) is high, the base station has difficulty in separating the signals received from the mobile stations.

The control unit 130, based on the spatial correlation value, the reception power ratio, the transmission timing difference, the power level, the fading rates, and the instantaneous errors those received from the signal processing unit 120, determines the validity of the space division multiplexing of the multiplex originating resource and the multiplex receiving resource and selects the multiplex originating resource and the multiplex receiving resource to which the space division multiplexing may be carried out (S302). The determination on the validity of the space division multiplexing is made by comparing between the index representing the communication quality such as the reception power ratio and the predetermined threshold of the index.

Then, the control unit 130 weights the spatial correlation value and the reception power ratio of the multiplex originating resource and the multiplex receiving resource that are selected with ΔF (a frequency difference between the multiplex originating resource and the multiplex receiving resource) (see Formula 5), and calculates the multiplexing priority such that the multiplexing priority becomes lower (i.e., a smaller number means a higher priority) as the ΔF becomes larger (S303).

Multiplexing Priority(l,m)=(1+ΔF)*(A*Spatial Correlation Value(l,m)+B*Power Ratio(l,m)) [Formula 5]

The control unit 130 may calculate the multiplexing priority in such a manner that a ratio of the spatial correlation value to the power ratio changes in accordance with ΔF (see Formulas 6 and 7) and the multiplexing priority becomes lower (i.e., the value is higher) as the ΔF becomes larger.

$$\begin{matrix}Multiplexing Priority ( l , m ) = \frac{\begin{matrix}( 1 + Δ F ) * A * Spatial Correlation Value ( l , m ) + \\ B * Power Ratio ( l , m )\end{matrix}}{( 1 + Δ F ) * A + B} & [ Formula 6 ] \\ Multiplexing Priority ( l , m ) = \frac{\begin{matrix}A * Spatial Correlation Value ( l , m ) + \\ ( 1 + Δ F ) * B * Power Ratio ( l , m )\end{matrix}}{A + ( 1 + Δ F ) * B} & [ Formula 7 ]\end{matrix}$$

Here, A and B are a weight coefficient of the spatial correlation value and a weight coefficient of the reception power ratio, respectively. The control unit 130, after calculating the multiplexing priority of all of the multiplex receiving resources to which the space division multiplexing may be carried out, carries out the space division multiplexing in relation to the multiplex receiving resource having high multiplexing priority, and then assigns the mobile station (multiplex call originator) and the mobile station (multiplex call receiver) to one radio resource (S304).

Further, the control unit 130, in assigning the radio resource, in order to minimize the frequency difference between the multiplex originating resource and the multiplex receiving resource, assigns the mobile station having made the connection request to the radio resource of the frequency the same as, or adjacent to, the radio resource used by another mobile station having made the connection request immediately prior to the mobile station and being connected.

### REFERENCE SIGNS LIST

10, 10-1 to 10-n mobile station
100 base station
110 radio communication unit
120 signal processing unit
130 control unit

1. A base station employing a TDD scheme and having a plurality of antennas for carrying out a radio communication by using an adaptive array method, wherein the base station
assigning, to a mobile station having made a connection request, a radio resource of a frequency band the same as, or adjacent to, a frequency band of a radio resource used by another mobile station having made the connection request immediately prior to the mobile station and being connected,
setting a multiplexing priority to each of mobile stations being connected relative to other mobile stations being connected, and
selecting, when there is no available radio resource to assign the mobile station that has made the connection request, a plurality of mobile stations being connected based on the multiplexing priority and assigning the selected plurality of mobile stations to one radio resource by employing an SDMA scheme.

2. The base station according to claim 1, wherein the multiplexing priority is set based on a spatial correlation value and a power ratio of each of the mobile stations being connected relative to other base stations being connected.

3. A base station employing a TDD scheme and having a plurality of antennas for carrying out a radio communication by using an adaptive array method, wherein the base station
setting a multiplexing priority to each of mobile stations being connected relative to other mobile stations being connected based at least on a frequency difference of radio resources of the mobile stations, and
selecting a plurality of mobile stations being connected based on the multiplexing priority and assigning the selected plurality of mobile stations to one radio resource by employing an SDMA scheme.

4. The base station according to claim 3, wherein the multiplexing priority is set based further on a spatial correlation value and a power ratio of each of the mobile stations being connected relative to other mobile stations being connected.

5. The base station according to claim 3, wherein a mobile station having made a connection request is assigned to a radio resource of a frequency band the same as, or adjacent to, a frequency band of a radio resource used by another base station having made the connection request immediately prior to the mobile station and being connected.

6. (canceled)

7. A communication control method of a base station employing a TDD scheme and having a plurality of antennas for carrying out a radio communication by using an adaptive array method, the communication control method comprising:
a step of setting a multiplexing priority to each of mobile stations being connected relative to other mobile stations being connected based at least on a frequency difference of radio resources between the mobile stations; and
a step of selecting a plurality of mobile stations being connected based on the multiplexing priority and assigning the selected plurality of mobile stations to one radio resource by employing an SDMA scheme.
